(19) United States
(12) Patent Application Publication
(10) Pub. No.: US 2025/0347837 A1
(43) Pub. Date: Nov. 13, 2025

(54) REFLECTIVE WAVEGUIDE WITH LIGHT RECYCLING MIRRORS

(71) Applicant: GOOGLE LLC, Mountain View, CA (US)

(72) Inventors: Alexander Koshelev, Kirkland, WA (US); Christophe Peroz, Zollikon (CH)

(21) Appl. No.: 19/199,603

(22) Filed: May 6, 2025

Related U.S. Application Data
(60) Provisional application No. 63/643,726, filed on May 7, 2024.

(51) Int. Cl. F21V 8/00; G02B 27/00

(52) U.S. Cl. CPC G02B 6/0016; G02B 6/0031; G02B 27/0081

(57) ABSTRACT

A waveguide includes a first configuration having an input coupler, an exit pupil expander, and an output coupler comprised of a first mirror array and a second mirror array. The first configuration further includes a light recycling mirror array disposed at an end opposite the exit pupil expander. Alternatively, or in addition to the first configuration, the waveguide includes a second configuration having a first light recycling mirror disposed at a first side of the exit pupil expander and a second light recycling mirror disposed at a second side of the exit pupil expander.

### BACKGROUND

A reflective waveguide is an optical component that typically incorporates semi-reflective mirrors positioned to modulate light transmission through partial reflection. This design manipulates the light path to expand the exit pupil, which determines the size of the image visible to the user. By adjusting the orientation and properties of these mirrors, it is possible to expand the pupil in specific directions (i.e., horizontally, vertically, or both) according to the desired field of view. This expansion allows for a wide viewing angle to be achieved, making the technology adaptable for various applications in compact optical systems such as augmented reality (AR) wearable display devices, mixed reality (MR) wearable display devices, heads-up displays (HUDs), and the like.

### SUMMARY OF EMBODIMENTS

In accordance with one aspect, a waveguide includes an input coupler, an exit pupil expander, an output coupler; and one or more light recycling mirrors configured to redirect light propagating through the waveguide for reuse in forming an image.

In at least some embodiments, the one or more light recycling mirrors are disposed at an end of the waveguide opposite the exit pupil expander.

In at least some embodiments, the waveguide includes one or more additional light recycling mirrors disposed adjacent to the input coupler.

In at least some embodiments, the output coupler includes a first mirror array a second mirror array, wherein the one or more light recycling mirrors are configured to reflect light that has passed through the output coupler back toward the second mirror array.

In at least some embodiments, the first mirror array and the second mirror array are oriented such that their surface normals lie substantially within a common plane, and are further configured such that an angular relationship α=β+γ is satisfied, wherein α is an angle between the one or more light recycling mirrors and a plane of the waveguide, β is an angle between the first mirror array and the plane of the waveguide, γ is an angle between the second mirror array and the plane of the waveguide, whereby light reflected from the second mirror array forms an image overlapping an image formed by light reflected from the first mirror array.

In at least some embodiments, at least one of the one or more light recycling mirrors includes a mirror array or a single edge mirror covering a majority of a cross-section of the waveguide.

In at least some embodiments, at least one of the one or more light recycling mirrors has an angularly selective coating configured to reflect light propagating through the waveguide while minimizing reflectance for see-through directions.

In at least some embodiments, the first mirror array and the second mirror array are polarization-sensitive, and at least one of the one or more light recycling mirrors includes a coating configured to rotate a polarization state of light, such that the second mirror array reflects the rotated light.

In at least some embodiments, the one or more light recycling mirrors include a first light recycling mirror disposed at a first side of the exit pupil expander and a second light recycling mirror disposed at a second side of the exit pupil expander.

In at least some embodiments, the light redirected by the first light recycling mirror is reflected by the exit pupil expander toward the second light recycling mirror, and is then reflected toward the output coupler.

In at least some embodiments, the exit pupil expander includes an array of mirrors configured to reflect light propagating in both forward and reverse propagating directions, such that overlapping images are formed.

In at least some embodiments, the first light recycling mirror, the second light recycling mirror, and the array of mirrors angularly arranged such that a plane of the array or mirrors bisects an angle formed by the first light recycling mirror and the second light recycling mirror.

In at least some embodiments, the first light recycling mirror and the second light recycling mirror are disposed such that their surface normals lie substantially in the plane of the waveguide.

In accordance with another aspect, wearable head-mounted display system includes an image source to project light comprising an image and a waveguide. The waveguide includes an input coupler, an exit pupil expander, an output coupler, and one or more light recycling mirrors configured to redirect light propagating through the waveguide for reuse in forming the image.

In at least some embodiments, the output coupler includes a first mirror array and a second mirror array, wherein the one or more light recycling mirrors are configured to reflect light that has passed through the output coupler back toward the second mirror array.

In at least some embodiments, the first mirror array and the second mirror array are oriented such that their surface normals lie substantially within a common plane, and are further configured such that an angular relationship α=β+γ is satisfied, wherein α is an angle between the one or more light recycling mirrors and a plane of the waveguide, β is an angle between the first mirror array and the plane of the waveguide, γ is an angle between the second mirror array and the plane of the waveguide, whereby light reflected from the second mirror array forms an image overlapping an image formed by light reflected from the first mirror array.

In at least some embodiments, the one or more light recycling mirrors includes a first light recycling mirror disposed at a first side of the exit pupil expander, and a second light recycling mirror disposed at a second side of the exit pupil expander.

In at least some embodiments, the first light recycling mirror, the second light recycling mirror, and mirrors of the exit pupil expander are angularly arranged such that a plane of the mirrors of the exit pupil expander bisects an angle formed by the first light recycling mirror and the second light recycling mirror.

In accordance with a further aspect, a method, at a waveguide, includes directing light generated by an image source to an exit pupil expander using an input coupler. The light is propagated through the waveguide using the exit pupil expander toward an output coupler. A first portion of the light is reflected to form a first image using the output coupler. At least a second portion of the light propagating through the waveguide is recycled using one or more light recycling mirrors. At least a portion of the recycled second portion of the light is redirected toward the output coupler to form a second image overlapping the first image.

In at least some embodiments, recycling the at least a second portion of the light includes one of reflecting the second portion of the light using a light recycling mirror disposed at an end of the waveguide opposite the exit pupil expander or reflecting the second portion of the light using a first light recycling mirror disposed at a first side of the exit pupil expander, or redirecting the recycled light using a second light recycling mirror disposed at a second side of the exit pupil expander.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a schematic of a portion of a reflective waveguide in accordance with some embodiments.

FIG. 2 is a schematic of a portion of a reflective waveguide implementing light recycling in accordance with some embodiments.

FIG. 3 is a cross-sectional view of a reflective waveguide configured to recycle the light passing through an output coupler in accordance with some embodiments.

FIG. 4 is a cross-sectional view of a reflective waveguide configured to recycle the light passing through an output coupler and implementing an inverted recycling mirror in accordance with some embodiments.

FIG. 5 is a top view of an output coupler recycling mirror array in accordance with some embodiments.

FIG. 6 is a cross-sectional view of a reflective waveguide configured to recycle the light passing through an output coupler and implementing a single edge recycling mirror in accordance with some embodiments.

FIG. 7 is a top view of a reflective waveguide configured to recycle the light passing through an exit pupil expander, and implementing exit pupil expander mirrors and one or more recycling mirrors in accordance with some embodiments.

FIG. 8 is a top view of a reflective waveguide configured to recycle the light passing through an exit pupil expander and implementing an inverted orientation of the exit pupil expander mirrors of FIG. 7 in accordance with some embodiments.

FIG. 9 is a top view of a reflective waveguide configured to recycle the light passing through an exit pupil expander and implementing additional recycling mirrors in accordance with some embodiments.

FIG. 10 is a block diagram of a near-eye display (NED) system in accordance with some embodiments.

FIG. 11 is a diagram illustrating a light projection system with an optical scanner that includes an optical relay disposed between two scan mirrors in accordance with some embodiments.

FIG. 12 is a flow diagram illustrating a method for recycling light within a reflective waveguide by reusing light redirected by mirrors disposed around an exit pupil expander in accordance with some embodiments.

FIG. 13 is a flow diagram illustrating a method for recycling light within a reflective waveguide by combining output coupler recycling and exit pupil expander recycling in accordance with some embodiments.

### DETAILED DESCRIPTION

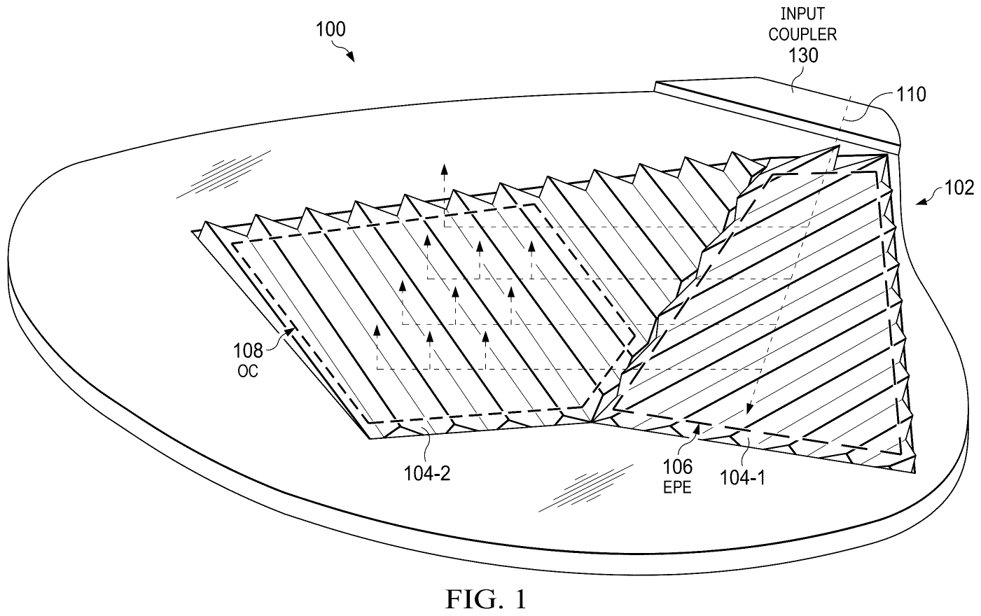

A reflective waveguide is a type of waveguide combiner used in immersive technology applications (e.g., AR and MR applications) where pupil expansion is accomplished using semi-reflective mirrors. These waveguides are typically designed with one-dimensional (1D) or two-dimensional (2D) expansion and fabricated into glass or polymer materials. FIG. 1 depicts a schematic 100 of an example architecture for a reflective waveguide 102, specifically a bottom half or portion of a polymer reflective waveguide. The reflective waveguide 102 includes two prism arrays 104 (illustrated as prism array 104-1 and prism array 104-2) defining an exit pupil expander (EPE) 106 and an output coupler (OC) 108. The prisms of the prism arrays 104 are coated with a partially reflective coating, such as a thin film multilayer dielectric coating. After completing the coating process, the bottom portion is bonded with the opposite part (e.g., the top half or portion), forming a flat waveguide that guides light 110 from an image source (e.g., a projector) via total internal reflection (TIR). The light 110 is first introduced into the waveguide using an input coupler (IC) 130, which may include a grating, prism, or other optical structure configured to couple the light into the waveguide at an appropriate angle. As the light 110 from the image source passes through a coated prism array 104, such as the EPE 106, the light 110 experiences partial reflection and is gradually directed towards the OC 108. Similarly, as the light 110 travels through the OC 108, the light 110 gradually outcouples towards the eye, forming the eyebox.

While reflective waveguides are generally known for their good color uniformity, they typically have limited efficiency and luminance uniformity. One reason is that as the light propagates through the prism array, the light intensity gets depleted due to multiple reflections. As a result, image brightness typically decreases for eyebox and field-of-view (FOV) positions that are further away from the input. This depletion is noticeable in the EPE and the OC prism arrays.

A variable mirror coating is one common way to improve efficiency and uniformity. In this approach, different portions of the EPE and OC prism arrays are coated with different coatings to compensate for light depletion. As an example, every next prism receives a different coating optimized to provide the best image uniformity. There are, however, limitations and disadvantages to this approach. First, this increases the fabrication complexity. This is especially problematic in the case of a polymer reflective waveguide, in which the entire prism array is typically fabricated at once. For these types of waveguides, applying multiple coatings results in a corresponding number of coating and masking steps, which increases the complexity. Furthermore, there is a limit to the mirror reflectivity due to the see-through and cosmetic limitations. In at least some instances, the reflectivity of the last mirror in an array should be, for example, 100% to maximize efficiency and uniformity. In practice, mirror reflectivity should be, for example, at most 10-20%. Otherwise, such a mirror would obstruct the user's view and be visible to an outside observer. Maintaining a low reflectivity for each mirror is beneficial for the social acceptability of the wearable display device (e.g., AR glasses) and to minimize various visual artifacts.

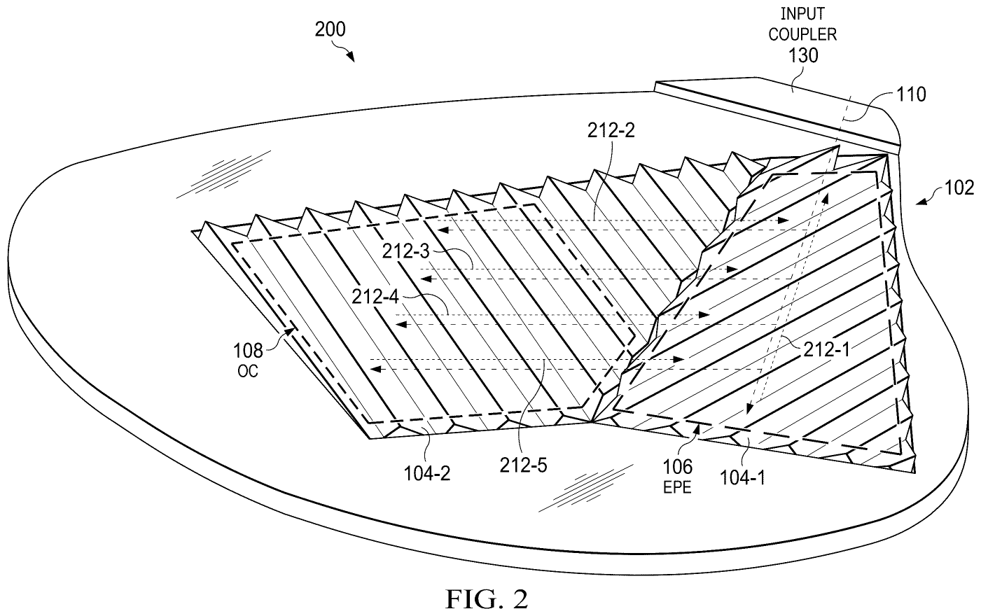

A better solution to improve image uniformity is to reuse the light that passes through the prism array without reflecting, as shown in the schematic 200 of FIG. 2. In FIG. 2, the dashed arrows 212 (illustrated as arrow 212-1 to arrow 212-5) represent recycled light. This approach can decrease the reflectivity of each mirror without reducing the overall efficiency since the light 110 effectively passes through twice as many mirrors. Reducing the mirror reflectivity can reduce the light depletion and improve the image uniformity. Furthermore, the light depletion direction is the opposite for the reused light, which additionally enhances image uniformity. However, while reflecting the light 110 back into the waveguide 102 is straightforward, to use the reflected light, at least two conditions should be fulfilled. First, as the light 110 travels through the prism array 104 a second time, the light 110 should be reflected in the same direction as during the first pass, that is, towards the eye, as it travels through the OC 108 and towards the OC 108 as it travels through the EPE 106. As can be seen, this is not the case for the waveguide configuration shown in FIG. 2. Second, the angle of the light 110 that reaches the eye during the second pass should be the same as during the first pass for the entire FOV to not create a double image.

Accordingly, described herein are example techniques and waveguide configurations implementing light recycling structures for increasing efficiency and luminance uniformity of immersive technology displays, such as AR and MR displays. In a first configuration, a reflective waveguide is configured to recycle the light passing through the OC. In a second configuration, the reflective waveguide is configured to recycle the light passing through the EPE. However, in at least some embodiments, the reflective waveguide implements both the first and second configurations such that the light passing through the OC is recycled and the light passing through the EPE is recycled.

As described in greater detail below, in the first configuration, the reflective waveguide implements three or a different number of mirror arrays, including a first set of mirrors and a second set of mirrors forming the OC and a third set of mirrors forming a light recycling mirror array. In at least some embodiments, the normals of all three sets of mirrors lie within the same plane. The first mirror array and the second mirror array may be oriented such that their surface normals lie substantially within a common plane, enabling angular relationships among the mirror arrays. This plane may be referred to as a common plane shared by the mirror arrays. To achieve efficient light recycling, the condition α=β+γ, in at least some embodiments, is fulfilled to ensure perfect overlap between the first and second images, where α is the angle between the light recycling mirror array and a plane of the waveguide, β is the angle between the first mirror array and the plane of the waveguide, and γ is the angle between the second mirror array and the plane of the waveguide.

In this first configuration, the light recycles by reflecting off the second set of mirrors while traveling in a negative Z-direction, creating a second image that overlaps with the first image. Both images are formed by light reflected from the mirror arrays during forward and reverse propagation. This approach eliminates gaps between the first set of mirrors, which would cause louver effects and image gaps. The recycling structures, in at least some embodiments, include coated prisms or embedded mirrors with reflectance between, for example, 10% and 100%. However, other reflectance values are applicable as well. The mirror coatings, in at least some embodiments, are configured to have specific reflectance vs. angle, ensuring high reflectivity (e.g., >90%) for display light propagating in the waveguide but low reflectivity for see-through directions. In at least some embodiments, the recycling mirror (third set of mirrors) is implemented as a single edge mirror covering the majority of the waveguide cross-section or a mirror array with a Fresnel break. The recycling mirror, in at least some embodiments, is configured to have angular selectivity to minimize stray light and image ghosts. Also, in at least some embodiments, the coatings of the first and second sets of mirrors, which define the OC mirrors, are configured to be polarization-sensitive, which minimizes reflectance from the second set of mirrors during forward propagation. This configuration ensures that the first set of mirrors primarily reflects p-polarized light, while the second set of mirrors primarily reflects s-polarized light. The advantages of the first configuration include, for example, improved display efficiency through optimized light recycling, reduced louver effects and image gaps by eliminating gaps between mirrors, increased uniformity in display brightness across the viewing area, and a compact design with a reduced waveguide footprint.

In the second configuration, the reflective waveguide implements a single-edge mirror and redirects the first and second image paths without introducing a second set of mirrors, thereby reducing stray light and image ghosting. In this configuration, light that did not get reflected towards OC is reflected back towards the EPE using a first recycling mirror. This light is then reflected away from the OC with the original EPE mirror due to its positive Y-direction travel. A second recycling mirror reflects the light back towards the OC. In at least some embodiments, the total number of reflections is reduced by orienting the EPE mirrors to direct the first path light through the EPE and reflect this light towards the second recycling mirror away from the OC, which creates the first image path. An additional recycling mirror, in at least some embodiments, is added to recycle light that passes through the full EPE and is not deflected toward the second recycling mirror. This light then travels through the EPE in a positive Y-direction and reflects off the EPE mirrors to create the second image path. In this configuration, each image path has two reflections in the EPE region, which reduces pupil clipping and improves the overall resolution limit.

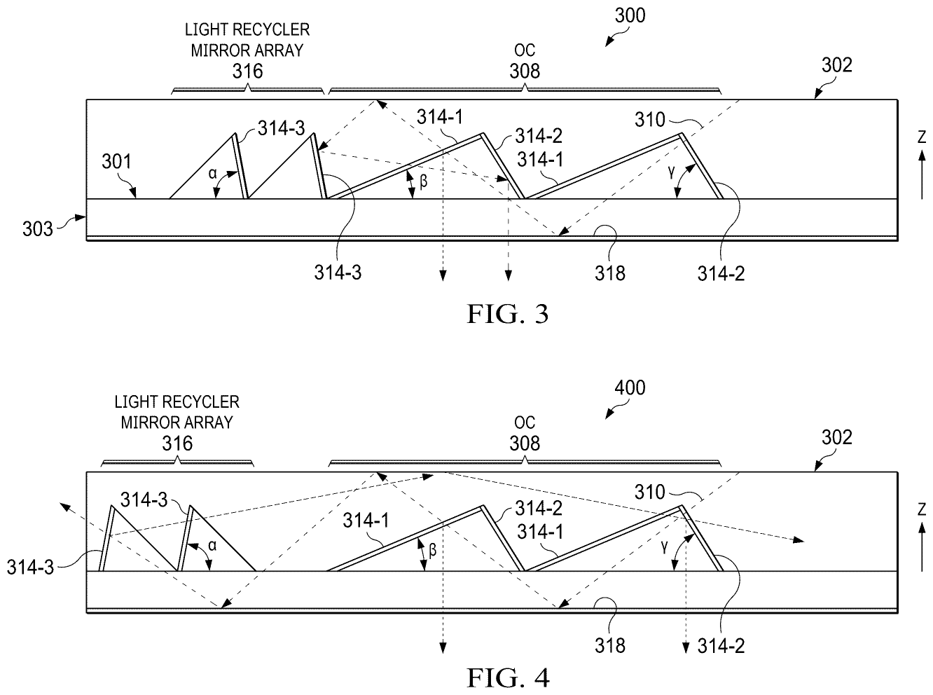

FIG. 3 illustrates a cross-sectional view 300 of a portion of a reflective waveguide 302 (also referred to herein as “waveguide 302”) implementing one or more light recycling structures for recycling light passing through an output coupler in accordance with one or more embodiments. In at least some embodiments, the waveguide 302 includes three mirror arrays 314 (illustrated as mirror array 314-1 to mirror array 314-3). The normals to all three mirror arrays 314, in at least some embodiments, belong to the same plane. FIG. 3 shows a cross-section of the mirror arrays 314 along this plane. The first mirror array 314-1 (e.g., M1 mirror array) and the second mirror array 314-2 (e.g., M2 mirror array) form the OC 308, while the third mirror array 314-3 forms the light recycling mirror array 316. The third mirror array 314-3, in at least some embodiments, is disposed at an end of the waveguide 302 opposite the EPE (not shown in FIG. 3). In at least some embodiments, the following condition is applied: α=β+β (within an accuracy of better than, for example, 3 arcmin), where α is the angle between the light recycling mirror array 316 and a plane 301 of the waveguide 302, β is the angle between the first mirror array 314-1 and the plane 301 of the waveguide 302, and γ is the angle between the second mirror array 314-2 and the plane 301 of the waveguide 302. An example is α=80°, β=23°, and γ=57°. This condition ensures that the images formed by the direct and recycled paths are aligned and do not create a double image. As used herein, “a plane of the waveguide 301” refers to the principal geometric plane 301 defined by the broad, major surfaces of the waveguide substrate 303.

As the light 310 travels from the EPE (not shown in FIG. 3) through the OC 308, which corresponds to the right-to-left direction in FIG. 4, the light 310 reflects from the first mirror array 314-1 while traveling in a positive Z-direction, creating the first image. The mirror coatings, in at least some embodiments, are configured to minimize the reflection of the light 310 from the first mirror array 314-1 when light 310 travels in a negative Z-direction. Additionally, the coating of the second mirror array 314-2 is configured to minimize the reflection of light 310 within the angle of incidence range corresponding to the forward propagation of light. After passing through the entire OC mirror array 314-1 and 314-2, the light 310 interacts with the light recycling mirror array 316. Upon reflection from the light recycler (or recycling) mirror array 316, the light 310 reflects from the second mirror array 314-2 while traveling in a negative Z-direction. This creates a second image.

The condition α=β+γ ensures that the first and second images perfectly overlap. For example, it is known that the composition of two reflections is equivalent to the rotation around the axis formed by the intersection of the mirrors by the double angle between mirrors. This equivalency is fulfilled for the entire FOV of the display. Now consider the ray traveling through the OC 308 in the negative Z-direction. The ray first reflects from the outer waveguide surface 318 and then from the first mirror array 314-1 to create the first image. The composition of these two reflections is equivalent to rotation around the axis normal to FIG. 3 by the angle 2*β. The light 310 first reflects from the light recycling mirror array 316 and then from the second mirror array 314-2 to form the second image. The composition of these two reflections is a rotation around the same axis normal to FIG. 3 by the angle 2*(α-γ). The following equation is true: 2*β=2*(α-γ) for the second and third images to overlap, which is fulfilled based on the original requirement.

Another combination of mirror array angles is shown in FIG. 4, which illustrates another cross-sectional view 400 of the waveguide 302. In this implementation, the light recycling mirror array 316 is mirror-inverted relative to the TIR surface. This implementation operates identically to the one shown in FIG. 3, except that the ray travels in the positive Z-direction before interacting with the light recycling mirror array 316, as shown in FIG. 4.

Besides efficiency and uniformity improvement, the advantage of using the light recycling mirror array 316 in the OC 308 is that the light 310 comes out from every portion of the output coupler prism array area. Without a recycler, the light 310 would only be extracted from the first mirror array 314-1. Due to fabrication limitations of the injection molding process, it is sometimes challenging to fabricate a mirror array without the gaps between the mirrors. The gaps between the first mirror array 314-1 would lead to the louver effect and image gaps. However, in the described configuration with light recycling mirror array 316, the image gaps are filled with the light 310 traveling in the opposite direction and reflecting from the third mirror array 314-3.

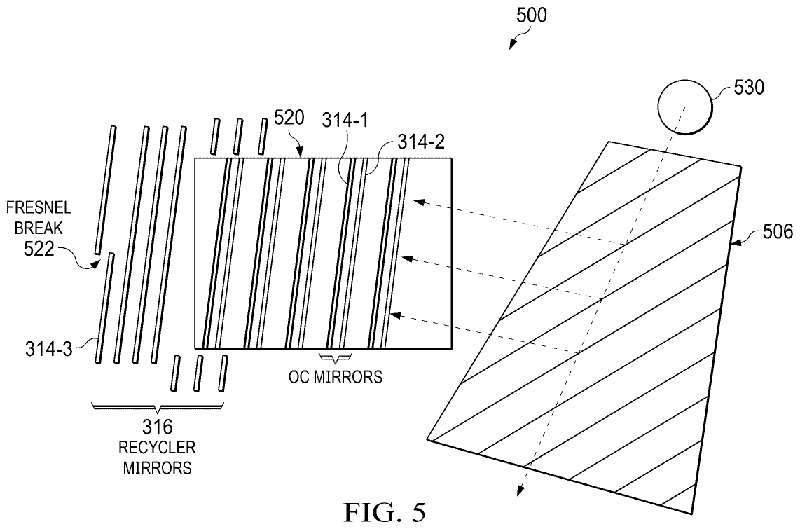

In at least some embodiments, the recycling structures include coated prisms or embedded mirrors with a reflectance between, for example, 10% and 100%. However, other reflectance values are applicable as well. The reflectance of the recycling structure, in at least some embodiments, depends on the position in the display area. The mirror, in at least some embodiments, is configured to have a specific reflectance versus angle such that the reflectance is high for the display light propagating in the waveguide while minimizing reflectance for see-through directions. This may be achieved, for example, using an angularly selective coating. The reflective structures, such as the light recycling mirror array 316, in at least some embodiments, are placed around the output coupler (OC) area 520, as shown in FIG. 5, or into the frame, depending on their reflectance. Also shown in FIG. 5 are an IC 530 and an EPE 506, which guide the display light 510 into and through the waveguide prior to reaching the output coupler region. At least a portion of the light recycling mirror array 316, in at least some embodiments, has a Fresnel break 522 to conform to the frame. A Fresnel break is when a portion of the mirror is translated spatially while remaining parallel to the rest of the mirror or mirror array.

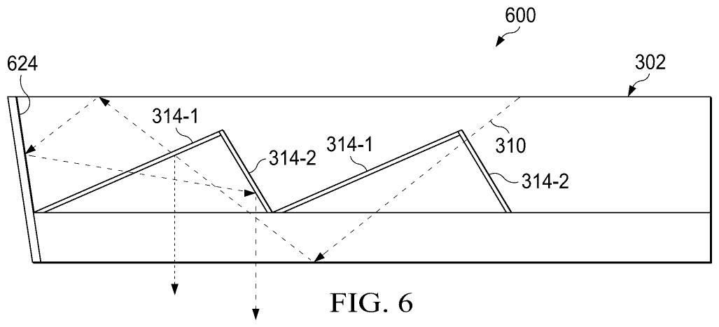

In at least some embodiments, the light recycling mirror array 316 is implemented as a mirror array, as shown in FIG. 3 and FIG. 4. A mirror array is advantageous in cases where position-dependent reflectivity is desired, such as for brightness compensation across the field of view or to accommodate varying image engine characteristics. Mirror arrays can also offer finer control over angular selectivity and reduce ghosting artifacts through customized spacing or Fresnel breaks. In other embodiments, instead of an array, a light recycling mirror is implemented that is formed by a single edge mirror 624, as shown in the cross-sectional view 600 of FIG. 6. In these embodiments, the single edge mirror 624 has high reflectivity (e.g., >90%) and covers the majority of the waveguide cross-section. Such a mirror 624, in at least some embodiments, is fabricated by polishing or micromachining the edge of the bonded waveguide. The advantage of this approach lies in its high efficiency and compact form factor. A single edge mirror provides a monolithic structure that simplifies fabrication and reduces alignment tolerances, which is particularly beneficial for polymer waveguides where space constraints limit the use of larger or segmented optics. This configuration is well-suited for applications requiring high luminance uniformity within a narrow waveguide profile.

In at least some embodiments, a configuration is implemented with α=90°. The advantage of this configuration is that it combines the light paths shown in FIG. 3 and FIG. 4 into the same image. Consider the reflection from the light recycling mirror array 316 in FIG. 3. As shown, the light 310 traveling in the negative Z-direction reflects from the light recycling mirror array and contributes to the image. However, the light 310 traveling in the positive Z-direction, if reflected from the light recycling mirror array, would have a different propagation direction and, therefore, could create stray light or even an image ghost if the light path ends up in the eyebox. In at least some embodiments, this impact is minimized by configuring the mirror coating to be angularly selective. On the other hand, if α=90°, then the images created by the reflection of positive Z-direction light and negative Z-direction light overlap. This eliminates the issue of stray light and improves efficiency. In at least some embodiments, the accuracy of the α angle is greater than ˜0.2-2 arcmin to avoid a double image. However, other accuracies are applicable as well.

The coatings of the OC mirrors, e.g., the first mirror array 314-1 and the second mirror array 314-2, in at least some embodiments, are configured to be polarization sensitive to minimize light reflectance from the third mirror array 314-3 during the forward propagation. In this case, the light 310 entering the OC region is assumed to be partially polarized. The partial polarization, in at least some instances, results from a polarized light engine (e.g., a Liquid Crystal on Silicon (LCOS) light engine). Alternatively, even with a non-polarized light engine (e.g., a micro Light Emitting Diode (uLED) light engine), the light entering the OC 308, in at least some instances, is partially polarized due to the reflection from the EPE, if EPE reflectivity is polarization sensitive. In addition, in at least some embodiments, a film or coating, such as birefringent, is applied to the surface of the waveguide to control the polarization rotation during the TIR reflection. Assuming that a partially polarized (e.g., p-polarized) light enters the OC 308, the coating of the third mirror array 314-3, in at least some embodiments, is configured to primarily reflect s-polarized light. In this case, the light is not reflected efficiently by the third mirror array 314-3 during the forward propagation path. However, upon reflection, the polarization state may be altered, resulting in rotated light that is more effectively reflected during the reverse propagation path. In at least some embodiments, the light recycling mirror array 316 has a coating acting as a quarter wave plate to convert the partially p-polarized light into partially s-polarized light upon reflection. Thus, the reflectance of the third mirror array 314-3 is high for the backpropagation path. The reflectance of the first mirror array 314-1, in at least some embodiments, is optimized to be polarization sensitive to reflect primarily p-polarized light. This ensures that the first mirror array 314-1 primarily reflects light during the forward propagation.

The specific polarization characteristics of the image source can further influence the configuration of coatings for the recycling mirrors. In embodiments employing a polarized light engine, such as LCOS or OLED-on-silicon systems, the polarization state of the display light is well defined, allowing the recycling mirrors to be optimized for specific polarization channels. In such configurations, additional polarization rotators (e.g., quarter-wave or half-wave plates) may be incorporated along the recycling path to maintain alignment with the preferred reflectance axis of the output coupler. Conversely, for micro-LED (uLED) systems that emit unpolarized light, partial polarization may still occur as a result of oblique reflection off the EPE mirrors. To improve recycling efficiency in these cases, coatings may be configured with broader polarization bandwidths or with angular selectivity that compensates for the distribution of polarization states in the input beam.

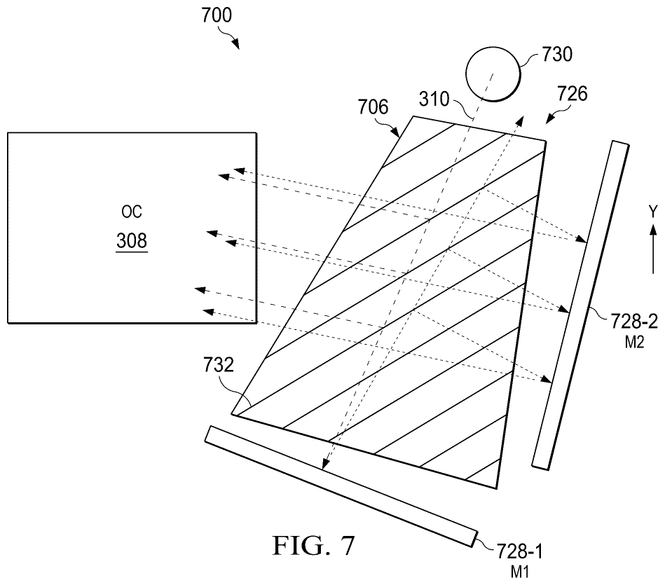

In another configuration, the reflective waveguide 302 implements an EPE recycler instead of, or in addition to, the OC light recycler described above with respect to FIG. 3 to FIG. 6. One difference of the EPE light recycler is that using the same EPE mirror array to redirect the first and second image path is possible. By not introducing a second set of mirrors (e.g., the second mirror array 314-2 of the OC light recycler in FIG. 3 to FIG. 6) reduces the chance of stray light and image ghosting. FIG. 7 shows a schematic 700 of an EPE light recycler 726. Only the azimuthal angle direction is shown in FIG. 7. It should be understood that although each mirror 728 (illustrated as first mirror 728-1 and second mirror 728-2) of the EPE light recycler 726 is represented as a single edge mirror, in other embodiments, a mirror array is used in place of one or both edge mirrors.

FIG. 7 shows a portion of the reflective waveguide 302, including an input coupler (IC) 730, the EPE 706, the OC 308, and the EPE light recycler 726. In at least some embodiments, the EPE light recycler 726 is comprised of a first recycling mirror 728-1 (e.g., an M1 mirror) and a second recycling mirror 728-2 (e.g., an M2 mirror). In at least some embodiments, the first recycling mirror 728-1 is disposed at a first side of the EPE 706, and the second recycling mirror 728-2 is disposed at a second side of the EPE 706. In the example shown in FIG. 7, the light 310 passes through the EPE 706 and reflects towards OC 308 as normal. The light 310 not reflected towards OC 308 reaches the first recycling mirror 728-1 and reflects back towards the EPE 706. Then, the light 310 is reflected by the original EPE mirror(s) 732. However, because the light 310 now travels in the positive Y-direction, the EPE mirror 732 reflects the light away from the OC 308. A second recycling mirror 728-2 is then used to reflect the light 310 back towards OC 308. Similar to the (OC) recycling mirror(s) 316 described above with respect to FIG. 3 to FIG. 6, the composition of all reflections for path 1 (solid line) and path 2 (dashed line) is identical so that the images created by following the two paths perfectly overlap for any FOV.

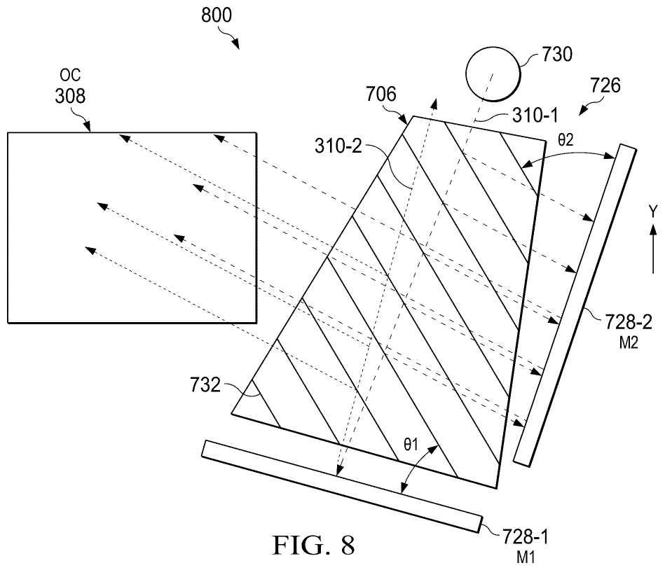

In the configuration of FIG. 7, path 2 has three reflections instead of one. Because the alignment between the light beam and mirrors is not controlled and changes for different field angles, each reflection from a mirror causes a certain amount of pupil clipping. Pupil clipping, in turn, reduces the resolution limit determined by the diffraction. Since path 2 experiences three mirror reflections in the EPE 706, the resolution limit of this beam is reduced, affecting the resolution of the entire image. However, FIG. 8 shows a schematic 800 illustrating a configuration of the reflective waveguide 302 for reducing the total number of reflections. In this configuration, the orientation of the EPE mirrors 732 is flipped to direct first path light 310-1 through the EPE 706 and then reflect the light 310-1 towards the second recycling mirror 728-2, away from the OC 308. This light 310-1 is then reflected from the second recycling mirror 728-2 towards the OC 308, creating the first image path. In at least some embodiments, an additional mirror, such as the first recycling mirror 728-1, is added to recycle the light 710-2 that passes through the full EPE 706 and is not deflected toward the second recycling mirror 728-2. As this light 310-2 travels through the EPE 706 in a positive Y-direction, the light 310-2 is reflected by the EPE mirrors 732 to the left towards the OC 308. This creates the second image path. Each image path is formed using light redirected within the waveguide and reflected toward the output coupler. Note that the light 710 of the first and second image paths experienced only two reflections each in the EPE region. These image paths are arranged such that overlapping images are formed at the output coupler from light traveling in both directions. The light forming the first and second image paths propagates in forward and reverse propagation directions through the EPE region. Reducing the number of reflections and pupil clipping by implementing the configuration of FIG. 8 improves the overall resolution limit.

As described above, to avoid a double image effect, the composition of the mirror reflections for the light following both paths, in at least some embodiments, are identical. For the configuration of FIG. 7, this condition is represented by the following equation: R_{M1}⊗R_{EPE}=R_{EPE}⊗R_{M2}, where R_{M1} is reflection around the first recycling mirror 728-1 (M1), R_{EPE} is a reflection around the EPE mirror 732, and R_{M2} is a reflection around the second recycling mirror 728-2 (M2). Since a rotation around the common axis can replace two subsequent reflections, this condition can be simplified to state that the EPE mirror 732 is a bisector plane of the first recycling mirror 728-1 and the second recycling mirror 728-2.

An example of this solution is when the first recycling mirror 728-1, the second recycling mirror 728-2, and the EPE mirrors 732 have a polar angle equal to 90°. That is, the surface normal of these mirrors lie in (or substantially in) the plane of the waveguide. The EPE mirror(s) 732 bisects the angle created by the first recycling mirror 728-1 and the second recycling mirror 728-2, that is θ1=θ2. This combination of mirror angles fulfills the condition above for perfect overlap between the images reflected from the first recycling mirror 728-1 and the second recycling mirror 728-2, such that light reflected from each recycling mirror is directed to overlap at the output coupler, forming a single combined image. Therefore, no double image is created. In addition, having the first recycling mirror 728-1 and the second recycling mirror 728-2 normal to the waveguide 302 surface ensures that all the light 310 reflected from them, whether the light 310 travels in the positive or negative Z-direction, contributes to the image instead of creating stray light or ghost. Similar to the recycling mirror 316 for the OC region, the first recycling mirror 728-1 and the second recycling mirror 728-2, in at least some embodiments, are mirror arrays or edge mirrors. The reflectivity of each mirror, in at least some embodiments, is between 10% and 100%. However, other reflectivity values are applicable as well. The angular dependence of the reflectivity, in at least some embodiments, is optimized to reduce the reflectivity for the see-through angles while preserving the reflectivity for the light engine angles. The mirrors, in at least some embodiments, are distributed throughout the waveguide area or hidden behind the frame of the glasses.

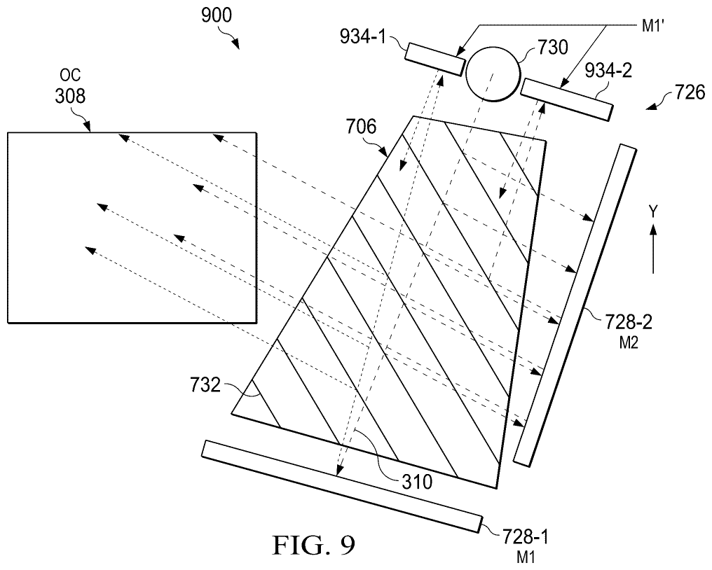

In at least some embodiments, additional mirrors 934 (illustrated as mirror 934-1 and mirror 934-2), such as additional light recycling mirrors, are placed around the IC 730, as shown in the schematic 900 of FIG. 9. These mirrors 934, in at least some embodiments, further recycle the backpropagated light and may be disposed adjacent to the input coupler. In at least some embodiments, the additional mirrors (M1′) 934 are recycling mirrors and are parallel to the first recycling mirror 728-1 so as not to create a double image. These additional mirrors 934, in at least some embodiments, recycle the light that was reflected from the first recycling mirror 728-1 but did not reflect from the EPE 706. Additionally, these mirrors 934, in at least some embodiments, recycle the light reflected from the second recycling mirror 728-2 but then reflected from the EPE 706 instead of propagating towards the OC 308. The composition of mirror transforms for both cases results in the null transformation, ensuring that the light reflected from the additional mirrors 934 propagates parallel to the original incoupled light 310 for all the field angles of the image. In other words:

$${R}_{M 1} ⊗ {R}_{M {1}^{′}} = {R}_{M 1} ⊗ {R}_{M 1} = 0 - path 1$$

$${R}_{EPE} ⊗ {R}_{M 2} ⊗ {R}_{EPE} ⊗ {R}_{M {1}^{′}} = {R}_{M 1} ⊗ {R}_{EPE} ⊗ {R}_{EPE} ⊗ {R}_{M {1}^{′}} = {R}_{M 1} ⊗ {R}_{M {1}^{′}} = {R}_{M 1} ⊗ {R}_{M 1} = 0 - path 2.$$

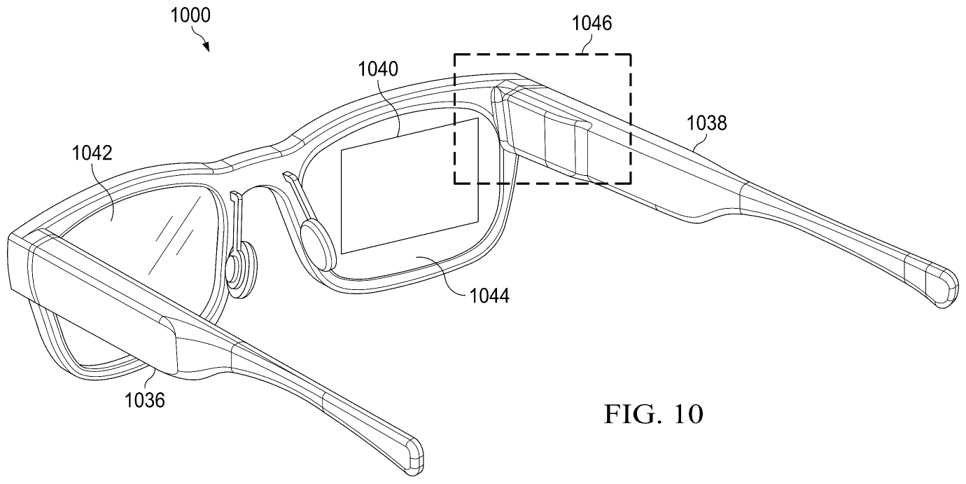

FIG. 10 illustrates an example near-eye display (NED) system 1000 for implementing a reflective waveguide, such as the reflective waveguide 302 of FIG. 3 to FIG. 9, having light recycling structures in accordance with at least some embodiments. In the illustrated implementation, the NED system 1000 utilizes an eyeglasses form factor. However, the NED system 1000 is not limited to this form factor and, thus, may have a different shape and appearance from the eyeglasses frame depicted in FIG. 10. The NED system 1000 includes a support structure 1036 (e.g., a support frame) to mount to a head of a user and that includes an arm 1038 that houses an image source, such as light projection system, including a micro-display (e.g., micro-light emitting diode (LED) display) or other light engine, configured to project display light representative of images or imagery toward the eye of a user, such that the user perceives the projected display light as a sequence of images displayed in a field of view (FOV) area 1040 at one or both of lens elements 1042, 1044 supported by the support structure 1036. In at least some embodiments, the support structure 1036 further includes various sensors, such as one or more front-facing cameras, rear-facing cameras, other light sensors, motion sensors, accelerometers, and the like. The support structure 1036, in at least some embodiments, further includes one or more radio frequency (RF) interfaces or other wireless interfaces, such as a Bluetooth(™) interface, a Wi-Fi interface, and the like.

The support structure 1036, in at least some embodiments, further includes one or more batteries or other portable power sources for supplying power to the electrical components of the NED system 1000. In at least some embodiments, some or all of these components of the NED system 1000 are fully or partially contained within an inner volume of support structure 1036, such as within the arm 1038 in region 1046 of the support structure 1036. In the illustrated implementation, the NED system 1000 utilizes an eyeglasses form factor. However, the NED system 1000 is not limited to this form factor and, thus, may have a different shape and appearance from the eyeglasses frame depicted in FIG. 10.

One or both of the lens elements 1042, 1044 are used by the NED system 1000 to provide an immersive display in which rendered graphical content can be superimposed over or otherwise provided in conjunction with a real-world view as perceived by the user through the lens elements 1042, 1044. For example, laser light or other display light is used to form a perceptible image or series of images projected onto the user's eye via one or more optical elements, including a waveguide, formed at least partially in the corresponding lens element. One or both of the lens elements 1042, 1044 thus include at least a portion of a waveguide that routes display light received by an IC (not shown in FIG. 10) of the waveguide to an OC (not shown in FIG. 10) of the waveguide, which outputs the display light toward an eye of a user of the NED system 1000. Additionally, the waveguide employs an EPE (not shown in FIG. 10) in the light path between the IC and OC or in combination with the OC to increase the dimensions of the display exit pupil. Each of the lens elements 1042, 1044 is sufficiently transparent to allow a user to see through the lens elements to provide a field of view of the user's real-world environment such that the image appears superimposed over at least a portion of the real-world environment.

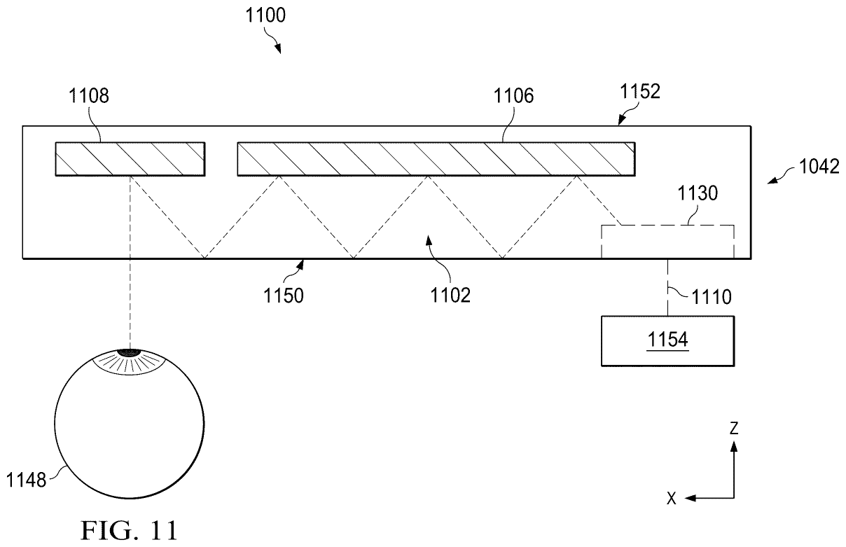

FIG. 11 depicts a cross-section view of an implementation of a display system 1100 (e.g., a near-eye display system or a wearable head-mounted display system) partially included in a lens element, such as lens element 1042, of an AR eyewear display system, such as NED system 1000, which in some embodiments includes a waveguide 1102, such as the waveguide 302 described above with respect to FIG. 3 to FIG. 9. The waveguide 1102 implements one or more one or more light recycling structures for recycling light passing through an EPE, an OC, or a combination thereof, as described above with respect to FIG. 3 to FIG. 9. Note that for illustration purposes, at least some dimensions in the Z-direction are exaggerated for improved visibility of the represented aspects.

The waveguide 1102 includes one or more waveguide gratings, such as an IC 1130, an EPE 1106, and an OC 1108. The term “waveguide”, as used herein, will be understood to mean a combiner using one or more of total internal reflection (TIR), specialized filters, and/or reflective surfaces to transfer light from an input coupler (such as the IC 1130) to an output coupler (such as the OC 1108). In some display applications, the light is a collimated image, and the waveguide transfers and replicates the collimated image to the eye. In general, an input coupler and output coupler each includes, for example, one or more optical grating structures, including, but not limited to, reflective gratings, diffraction gratings, holograms, holographic optical elements (e.g., optical elements using one or more holograms), volume diffraction gratings, volume holograms, surface relief diffraction gratings, and/or surface relief holograms. In at least some embodiments, a given input coupler or output coupler is a reflective grating (e.g., a reflective diffraction grating or a reflective holographic grating) that causes the input coupler or output coupler to reflect light and to apply configured optical function(s) to the light during the reflection. One or more of the input coupler 1130, the EPE 1106, or the OC 1108 are configured as described above with respect to FIG. 3 to FIG. 9. Also, one or more of the input coupler 1130, the EPE 506, or the OC 1108 are fabricated as part of the waveguide 1102 or are fabricated separately from the waveguide 1102 and then bonded thereto.

In the present example, the IC 1130 receives the display light 1110 and relays this light 1110 to the output coupler 1108 via the waveguide 1102 using TIR. For example, the IC 1130 directs the display light 1110 into the waveguide 1102. The EPE 1106 is arranged in an intermediate stage between IC 1130 and the OC 1108 to receive light that is coupled into waveguide 1102 by the IC 1130, expand the light, and redirect the light towards the OC 1108, where the OC 1108 then couples the light out of waveguide 1102 (e.g., toward the eye 1148 of the user). As described above, in some embodiments, the waveguide 1102 is implemented as part of an eyeglass lens, such as the lens 1042 or lens 1044 (FIG. 10) of the display system 1100 having an eyeglass form factor and employing the display system 1100.

In this example implementation, the waveguide 1102 implements facets as part of the EPE 1106, facets as part of the OC 1108, and facets as part of the IC 1130. The facets for these different components or regions are implemented toward the eye-facing side 1150 or the world-facing side 1152 of the waveguide 1102. Thus, under this approach, display light 1110 emitted or projected from a light source 1154 is incoupled to the waveguide 1102 via the IC 1130 and propagated (through total internal reflection in this example) toward the EPE 1106, whereupon the facets of the EPE 1106 reflect the incident display light for exit pupil expansion purposes, and the resulting light is propagated to the facets of the OC 1108, which output the display light toward a user's eye 1148.

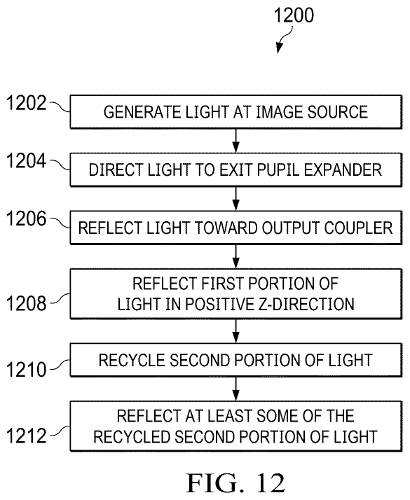

FIG. 12 illustrates a flow diagram of a method 1200 for recycling light within a reflective waveguide (e.g., waveguide 302), by overlapping image paths through an output coupler (e.g., OC 308). The processes described below with respect to method 1200 are detailed further with reference to FIG. 1 to FIG. 6 above. The method 1200 is not limited to the sequence of operations shown in FIG. 12, as at least some operations can occur in parallel or in a different sequence. Additionally, in at least some implementations, the method 1200 can include one or more different operations beyond those depicted in FIG. 12.

At block 1202, light 310 is generated by an image source. At block 1204, the light 310 is directed to an EPE 506 using an IC 530. The input coupler 530 includes, for example, a prism, diffraction grating, or other optical structure configured to inject the display light into the waveguide 302 with an angle suitable for total internal reflection (TIR). The injected light, in at least some embodiments, is collimated or partially collimated and corresponds to image content intended for display to the user. At block 1206, the light 310 is reflected by the EPE 1106 toward an OC 308. The EPE 506 includes an array of partially reflective structures, such as prism arrays 104 or mirrors, that progressively redirect portions of the guided light toward the output region. This pupil expansion increases the size of the eyebox and improves brightness uniformity across the field of view.

At block 1208, a first portion of the light 310 is reflected in a positive Z-direction using a first mirror array 314-1 of the output coupler 308, forming a first image. The first mirror array 314-1 includes a set of partially reflective elements arranged to extract light from the waveguide 302 and direct it toward the user's eye. This extraction occurs at multiple positions along the output region to enable consistent image formation over the full display area. At block 1210, at least a second portion of the light 310 that passes through the output coupler 308 is recycled onto a second mirror array 314-2 using at least one light recycling mirror 316. The light recycling mirror 316 is disposed at an end of the waveguide 302 opposite the EPE 506 and is configured to reflect the transmitted light back into the waveguide 302 to propagate in the reverse direction.

At block 1212, at least some of the second portion of the light 310, now traveling in a negative Z-direction, is reflected by the second mirror array 314-2 of the output coupler 308, forming a second image that overlaps with the first image. The angular relationship between the first mirror array 314-1, the second mirror array 314-2, and the recycling mirror 316 is configured to satisfy the condition α=β+γ, which ensures spatial alignment between the forward-propagated and recycled image paths. This overlap improves image uniformity, reduces brightness falloff, and enables efficient reuse of light that would otherwise be lost.

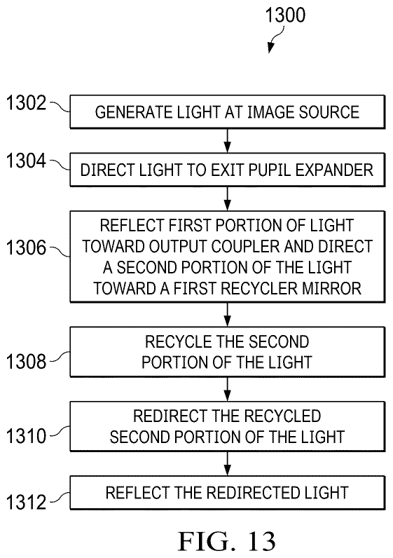

FIG. 13 illustrates a flow diagram of a method 1300 for recycling light within a reflective waveguide (e.g., waveguide 302) by reusing light reflected within and around an EPE structure (EPE 706). The processes described below with respect to method 1300 are detailed further with reference to FIG. 7 to FIG. 9 above. The method 1300 is not limited to the sequence of operations shown in FIG. 13, as at least some operations can occur in parallel or in a different sequence. Additionally, in at least some implementations, the method 1300 can include one or more different operations beyond those depicted in FIG. 13.

At block 1302, light 710 is generated by an image source. At block 1304, the light 310 is directed to an EPE 706 using an input coupler (IC) 730. The IC 730 includes, for example, a prism, diffraction grating, or other optical structure configured to inject the display light into the waveguide 302 at an angle appropriate for total internal reflection (TIR). In at least some embodiments, the injected light is collimated or partially collimated and corresponds to image content intended for display to the user.

At block 1306, a first portion of the light 710 is reflected by the EPE 706 toward an OC 308, and a second portion of the light 710 is directed toward a first recycling mirror 728-1. The EPE 706 includes an array of partially reflective mirrors or prisms 732 that redirect the guided light, expanding the exit pupil and increasing the angular and spatial range over which the image is visible. At block 1308, the second portion of the light 710 is recycled by reflecting it back to the EPE 706 using the first recycling mirror 728-1. The reflected light re-enters the EPE 706 from the opposite direction and interacts again with the EPE mirrors 732.

At block 1310, portions of the recycled second portion of the light 710 are redirected away from the OC 308 using the EPE 706 and then directed toward a second recycling mirror 728-2. The orientation of the EPE mirrors 732 causes the light, now traveling in the positive Y-direction, to be steered laterally away from the output region. The second recycling mirror 728-2 is positioned to intercept this light and redirect it back into the waveguide 302. At block 1312, the redirected light is reflected toward the output coupler 308 using the second recycling mirror 728-2. The combination of the first recycling mirror 728-1, the EPE mirror geometry, and the second recycling mirror 728-2 is configured to ensure that the total path of the recycled light matches that of the initial light directed to the output coupler. As a result, the recycled light forms a second image that overlaps with the first image. This configuration improves light efficiency, enhances luminance uniformity, and reduces brightness falloff across the field of view without introducing double images or stray light artifacts.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A waveguide, comprising:
an input coupler;
an exit pupil expander;
an output coupler; and
one or more light recycling mirrors configured to redirect light propagating through the waveguide for reuse in forming an image.

2. The waveguide of claim 1, wherein the one or more light recycling mirrors are disposed at an end of the waveguide opposite the exit pupil expander.

3. The waveguide of claim 2, further comprising:
one or more additional light recycling mirrors disposed adjacent to the input coupler.

4. The waveguide of claim 2, wherein the output coupler comprises:
a first mirror array; and
a second mirror array,
wherein the one or more light recycling mirrors are configured to reflect light that has passed through the output coupler back toward the second mirror array.

5. The waveguide of claim 4, wherein the first mirror array and the second mirror array are oriented such that their surface normals lie substantially within a common plane, and are further configured such that an angular relationship α=β+γ is satisfied, wherein:
α is an angle between the one or more light recycling mirrors and a plane of the waveguide;
β is an angle between the first mirror array and the plane of the waveguide; and
γ is an angle between the second mirror array and the plane of the waveguide,
whereby light reflected from the second mirror array forms an image overlapping an image formed by light reflected from the first mirror array.

6. The waveguide of claim 4, wherein at least one of the one or more light recycling mirrors comprises:
a mirror array or a single edge mirror covering a majority of a cross-section of the waveguide.

7. The waveguide of claim 4, wherein at least one of the one or more light recycling mirrors has an angularly selective coating configured to reflect light propagating through the waveguide while minimizing reflectance for see-through directions.

8. The waveguide of claim 4, wherein the first mirror array and the second mirror array are polarization-sensitive, and at least one of the one or more light recycling mirrors includes a coating configured to rotate a polarization state of light, such that the second mirror array reflects the rotated light.

9. The waveguide of claim 1, wherein the one or more light recycling mirrors comprise:
a first light recycling mirror disposed at a first side of the exit pupil expander; and
a second light recycling mirror disposed at a second side of the exit pupil expander.

10. The waveguide of claim 9, wherein the light redirected by the first light recycling mirror is reflected by the exit pupil expander toward the second light recycling mirror, and is then reflected toward the output coupler.

11. The waveguide of claim 10, wherein the exit pupil expander comprises:
an array of mirrors configured to reflect light propagating in both forward and reverse propagating directions, such that overlapping images are formed.

12. The waveguide of claim 11, wherein the first light recycling mirror, the second light recycling mirror, and the array of mirrors angularly arranged such that a plane of the array or mirrors bisects an angle formed by the first light recycling mirror and the second light recycling mirror.

13. The waveguide of claim 12, wherein the first light recycling mirror and the second light recycling mirror are disposed such that their surface normals lie substantially in the plane of the waveguide.

14. A wearable head-mounted display system comprising:
an image source to project light comprising an image; and
a waveguide, comprising:
an input coupler;
an exit pupil expander;
an output coupler; and
one or more light recycling mirrors configured to redirect light propagating through the waveguide for reuse in forming the image.

15. The wearable head-mounted display system of claim 14, wherein the output coupler comprises:
a first mirror array; and
a second mirror array,
wherein the one or more light recycling mirrors are configured to reflect light that has passed through the output coupler back toward the second mirror array.

16. The wearable head-mounted display system of claim 15, wherein the first mirror array and the second mirror array are oriented such that their surface normals lie substantially within a common plane, and are further configured such that an angular relationship α=β+γ is satisfied, wherein:
α is an angle between the one or more light recycling mirrors and a plane of the waveguide;
β is an angle between the first mirror array and the plane of the waveguide; and
γ is an angle between the second mirror array and the plane of the waveguide,
whereby light reflected from the second mirror array forms an image overlapping an image formed by light reflected from the first mirror array.

17. The wearable head-mounted display system of claim 14, wherein the one or more light recycling mirrors comprise:
a first light recycling mirror disposed at a first side of the exit pupil expander; and
a second light recycling mirror disposed at a second side of the exit pupil expander.

18. The wearable head-mounted display system of claim 17, wherein the first light recycling mirror, the second light recycling mirror, and mirrors of the exit pupil expander are angularly arranged such that a plane of the mirrors of the exit pupil expander bisects an angle formed by the first light recycling mirror and the second light recycling mirror.

19. A method, at a waveguide, comprising:
directing light generated by an image source to an exit pupil expander using an input coupler;
propagating the light through the waveguide using the exit pupil expander toward an output coupler;
reflecting a first portion of the light to form a first image using the output coupler;
recycling at least a second portion of the light propagating through the waveguide using one or more light recycling mirrors; and
redirecting at least a portion of the recycled second portion of the light toward the output coupler to form a second image overlapping the first image.

20. The method of claim 19, wherein recycling the at least a second portion of the light comprises one of:
reflecting the second portion of the light using a light recycling mirror disposed at an end of the waveguide opposite the exit pupil expander, or
reflecting the second portion of the light using a first light recycling mirror disposed at a first side of the exit pupil expander; or
redirecting the recycled light using a second light recycling mirror disposed at a second side of the exit pupil expander.
